(19) United States
(12) Patent Application Publication
(10) Pub. No.: US 2026/0311541 A1
(43) Pub. Date: Oct. 8, 2026

(54) BARTOP GAMING DEVICE WITH PORTRAIT ORIENTED VIDEO DISPLAY

(71) Applicant: Playrtech LLC, Las Vegas, NV (US)

(72) Inventors: Pierre Keylian, Henderson, NV (US); Ara Tcholakian, Las Vegas, NV (US); Ryan Banks, Las Vegas (UA); Ryan Baxter, Henderson, NV (US)

(21) Appl. No.: 19/709,939

(22) Filed: Jun. 16, 2026

Related U.S. Application Data
(63) Continuation of application No. 30/034,563, filed on Nov. 25, 2025.
Application No. 30/034,563 is a division of application No. 29/899,915, filed on Aug. 15, 2023, now Pat. No. D1107124.

(51) Int. Cl. G07F 17/32

(52) U.S. Cl. CPC G07F 17/3211; G07F 17/3209

(57) ABSTRACT

A bar top gaming unit has a front and a video display which is oriented in a portrait orientation relative to the front. The bar top gaming unit has a housing with a base portion having a bottom and at least one wall extending upwardly to a top which defines an interior area for housing components of the bar top gaming unit, a top door located at the top of the base portion and a display mount associated with the top door, where the video display is supported by the display mount and angles upwardly the top door from a bottom to a top of the video display.

### CROSS-REFERENCE TO RELATED APPLICATIONS

This application is a continuation of U.S. Design application Ser. No. 30/034,563, filed Nov. 25, 2025, which is a divisional of U.S. Design application Ser. No. 29/899,915, filed Aug. 15, 2023, now U.S. Pat. No. D1107124.

### FIELD OF THE INVENTION

The present invention relates to devices which are used to present video-based games such as wagering games.

### BACKGROUND OF THE INVENTION

A wide variety of configurations of gaming machines are well-known. For use on a casino floor, such gaming machines often have a “slant top” or “upright” configuration where the cabinet of the gaming machine extends generally vertically. This allows the gaming machine to be set on the floor or on a gaming machine stand and have a height which is suitable for play by a player.

This style of gaming machine, however, does not work well in bar top environments. In a bar top environment, the bar has a raised serving surface, such that if the gaming machine is placed thereon, it would be too tall to be played by a player and would also block the bar behind the bar top. As a result, bar top gaming machines generally have a low profile, with a housing which is desired to sit at least partially below the bar top surface and having a top which is located at or above the bar top. The game display is associated with the top of the bar top gaming machine so that it sits at or slightly above the bar top and can easily be viewed by a player sitting at the bar.

Several problems exist with existing bar top gaming machines. For example, these gaming machines are often difficult to service and/or have expensive and complex designs owing to their unique configuration.

An improved bar top gaming unit is desired.

### BRIEF SUMMARY OF THE INVENTION

Aspects of the disclosure comprise a bar top gaming unit or machine, including a configuration thereof and features thereof.

In one embodiment, a bar top gaming unit has a front and a video display which is oriented in a portrait orientation relative to the front.

In one embodiment, the bar top gaming unit may comprise a housing comprising a base portion having a bottom and at least one wall extending upwardly to a top, the base portion generally defining an interior area for housing one or more components of the bar top gaming unit, a top door located at the top of the base portion and a display mount associated with the top door, where the housing has a front and an opposing rear and first and second sides and a first direction that is generally parallel to the first and second sides and perpendicular to the front and rear and a second direction that is generally parallel to the front and rear and perpendicular to the first and second sides, and a video display having a top and a bottom and a first side and a second side, a first dimension D1 between the top and bottom which is greater than a second distance D2 between the first side and the second side, the video display connected to the display mount and oriented so that the dimension D1 extends parallel to the first direction and generally perpendicular to the second direction.

In one embodiment, the video display may be angled upwardly from the bottom towards the top, such as at an angle of about 20 degrees relative to horizontal. In such a configuration, sides of the display mount may extend upwardly from the top door by a varied distance, such as by a greater distance at a rear of the display mount than a front thereof.

In one embodiment, a display face of the video display may be curved, such as concave curved between its top and bottom.

In some embodiments, a rear of the display mount and a top of the video display may extend rearwardly of or beyond a rear of the bar top gaming unit and above the top door.

Further objects, features, and advantages of the present invention over the prior art will become apparent from the detailed description of the drawings which follows, when considered with the attached figures.

### BRIEF DESCRIPTION OF THE DRAWINGS

FIG. 1 is a top perspective view of an embodiment of a bar top gaming unit in accordance with the disclosure;

FIG. 2 is a top view of the bar top gaming unit illustrated in FIG. 1;

FIG. 3 is a front plan view of the bar top gaming unit illustrated in FIG. 1; and

FIGS. 4 and 5 are first and second side plan views of the bar top gaming unit illustrated in FIG. 1.

### DETAILED DESCRIPTION OF THE INVENTION

In the following description, numerous specific details are set forth in order to provide a more thorough description of the present disclosure. It will be apparent, however, to one skilled in the art, that the present disclosure may be practiced without these specific details. In other instances, well-known features have not been described in detail so as not to obscure the disclosure.

One aspect of the disclosure is a bar top gaming unit or machine. It is noted that aspects of the invention relate to the configuration of a housing and/or other components of a bar top gaming machine. While the housing and related components comprise a portion of a completed bar top gaming machine that is configured to present one or more wagering games, it will be appreciated that some elements of a completed bar top gaming machine (for example, a gaming machine controller, etc., as further described below) are not required.

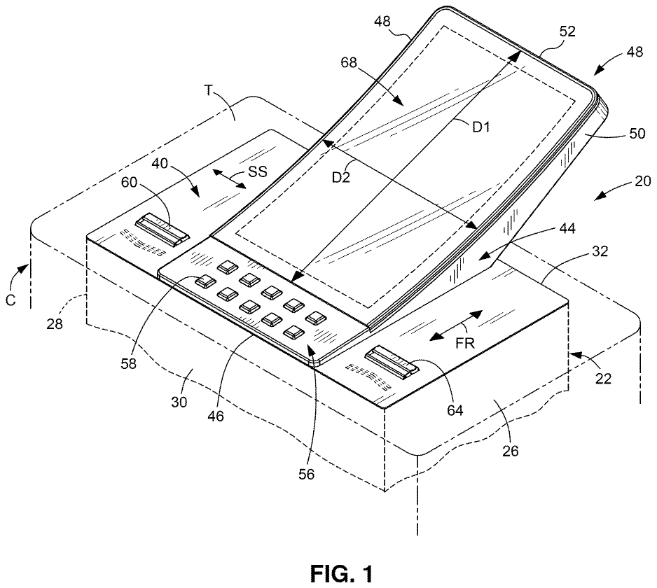

One embodiment of a bar top gaming unit 20 will be described with reference to FIG. 1. As illustrated therein, the bar top gaming unit 20 includes a base portion 22. In one embodiment, the base portion 22 is defined by a bottom and at least one wall extending upwardly from the bottom. In a preferred embodiment, first and second sides 26,28 extend upwardly from opposing edges of the bottom. The base portion 22 also includes front and rear walls 30,32 which extend upwardly from the bottom. The front and rear walls 30, 32 extend between the first and second sides 26,28, the walls and sides cooperating to define a perimeter of the base portion 22. In one embodiment, the base portion 22 is generally rectangular in shape, where the front and rear walls 30,32 are longer than the first and second sides 26,28. Of course, the base portion 22 might have other shapes, such as generally square, or where one or more of the sides or walls thereof are not linear, etc.

The bottom, first and second sides 26,28 and front and rear walls 30,32 of the base portion 22 may define a generally closed base portion interior area, such as for housing or containing various components of the bar top gaming unit 20. For example, as is known, gaming unit generally include components such as a gaming controller or processor with an associated memory, communication interface, etc., and other components such as a bill or ticket validator, card reader or other elements. The first and second sides 26,28 and front and rear walls 30,32 have a top edge forming the perimeter of a generally open top of the base portion 22.

In use, the bar top gaming unit 20 is advantageously configured to use with a bar having a cabinet C with a top T. The base portion 22 is preferably configured to fit within an opening defined by the cabinet C, such as by being placed downwardly through an opening in the top T.

As is common, the front wall may have one or more openings therein providing access to the interior of the base portion 22, such as from the cabinet C with which the bar top gaming unit 20 is associated. At least one panel or door may be movably connected to the base portion 22 for selectively opening and closing the opening(s) in the front wall 30. These panels or doors may have at least one locking element associated therewith, such as a key operated lock or an internally accessible latch, etc. for selectively controlling opening and closing thereof. For example, in one embodiment, a locking mechanism may comprise a simple rotating latch. The latch of the locking mechanism may be positioned at a rear of the panel with a key accepting actuator extending from a front side of the panel through the panel to the latch for rotating the latch. In use, turning of a key causes the latch to rotate into a first position in which it extends behind a portion of the front wall 30 opposing the panel preventing the front panel from being moved to an open position. Rotation of the latch into a second position out of engagement with the front wall 30 permits the panel to be opened. Further, similar openings might be provided at the side 26,28 or rear wall 32 of the base portion 22 in a similar manner.

In one configuration, a top door 40 cooperates with the base portion 22 to selectively close the top of the base portion 22. As is known, such doors are generally openable and closeable, thus enabling a user to open the top door 40 to gain access to the interior of the base portion 22. In one embodiment, the top door 40 also supports components of the bar top gaming unit 20, such as a console 56 and a video display 68, as described in more detail below.

With respect to the portion of the bar top gaming unit 20 which is generally visible to the player thereof as illustrated in FIG. 1, the unit 20 generally has a front, an opposing rear, a first side and an opposing second side, each of which may be defined by corresponding portions of the top door 40. In such a configuration, the bar top gaming unit 20 has a side to side “SS” direction which is generally perpendicular to the sides 26,28 of the base portion 22 and in the embodiment illustrated, the sides of the top door 40 and parallel to the front wall 30 and rear wall 32 of the base portion 22 and the top door 40 (noting that the sides and front/rear of the base portion and/or top door do not need to be perfectly linear), and has a front to rear “FR” direction which is generally perpendicular to the front wall 30 and rear wall 32 of the base portion 22 and the top door 40, and parallel to the sides 26,28 of the base portion 22 and the top door.

In one embodiment, a display mount 44 extends upwardly from the top door 40. The display mount 44 is preferably associated with the top door 40 and has a front 46, first and second sides 48,50 and a rear 52. In one embodiment, the first and second sides 48,50 extend in the “FR” direction and the front 46 and rear 52 extend in the “SS” direction.

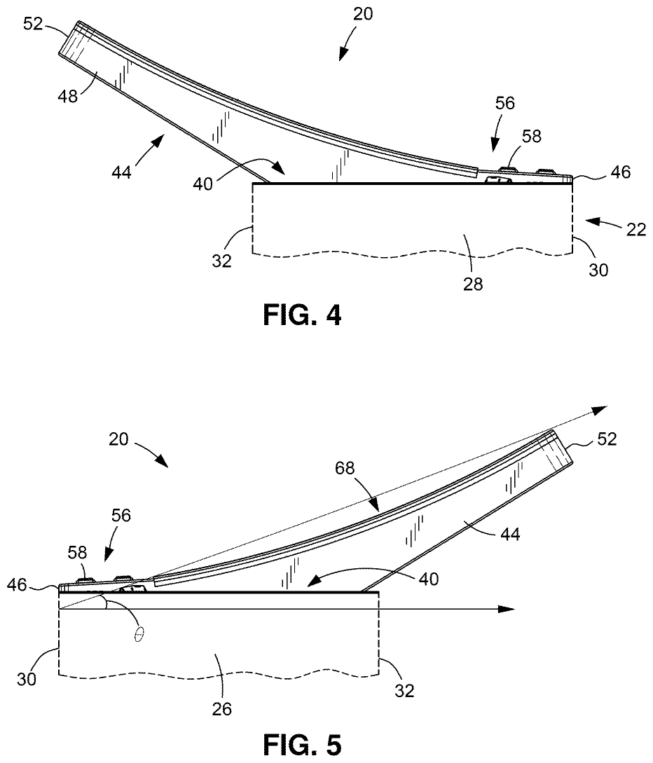

The display mount 44 may be connected to the top door 40, such as to be moveable therewith. As illustrated in FIG. 1, the front 46 of the display mount 44 may extend upwardly a first distance from the top door 40, while the rear 52 may extend upwardly a second distance above the top door 40. Preferably, the second distance is greater than the first distance. In this manner, as detailed below, the display mount 44 (and associated video display 68) slopes upwardly from front to back at an angle from horizontal. In such a configuration, the first and second sides 48,50 of the display mount 44 may extend upwardly a variable distance from the top door 40, such as a greater distance at the rear than the front. Further, as best illustrated in FIGS. 4 and 5, the rear 52 of the display mount 44 may extend not only upwardly from the top door 40, but at an angle thereto, and such that the rear 52 of the display mount 44 extends rearwardly of the top door 40 and the base portion 22. As illustrated, the display mount 44 generally extends the top of the bar top gaming unit 20 upwardly to a point above the bar top T.

It will be appreciated that while the display mount 44 may comprise one or more elements which are mounted to the top door 40 (such as metal members which are connected to metal members forming the top door 40), the display mount 44 may comprise a portion of the top door 40, such as extended portions of the sides and front and rear walls, etc. (whereby the display mount 44 effectively comprises a portion of the top door 40).

As noted, in a preferred embodiment, the top door 40 may be movably mounted to the base portion 22, such as in the manner described in U.S. Pat. No. 12,505,719, such as via a hinge that connects a back edge of the top door 40 to the base portion 22 and permits the top door 40 to be rotated into a closed position in which it extends over the otherwise open top of the base portion 22 and which permits the top door 40 to be rotated upwardly into a position in which it does not generally obscure the open top of the base portion 22, permitting access to the interior area.

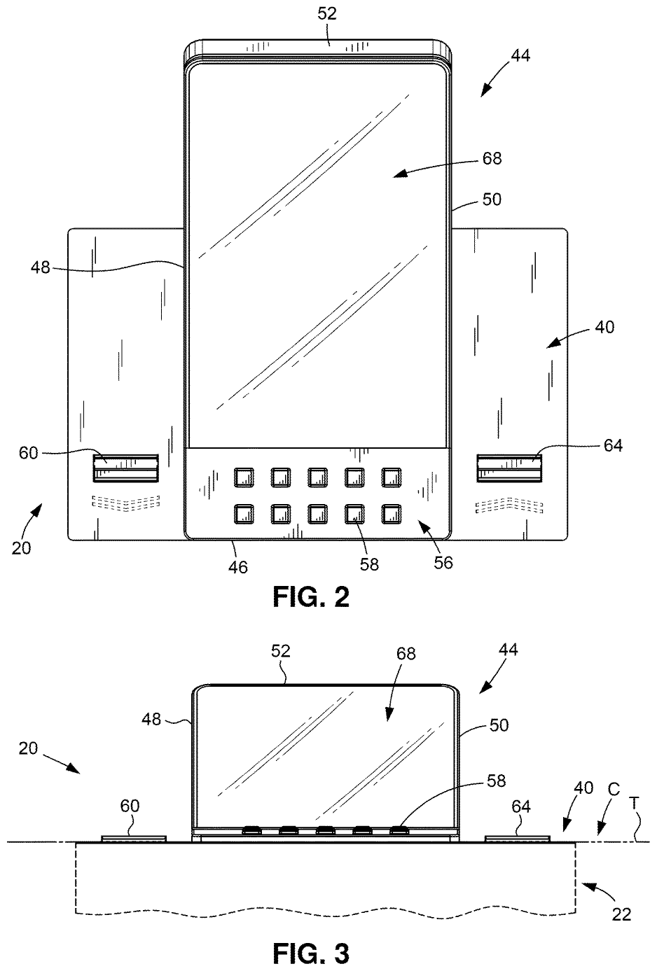

As indicated above and illustrated in FIGS. 1 and 2, the top door 40 and associated display mount 44 support components of the bar top gaming unit 20. For example, a console 56 may be located at the front 46 of the display mount 44. The console 56 might comprise, for example, a panel member. As illustrated, one or more player input devices 58 such as buttons or the like may be associated with the console 56.

As illustrated, the top door 40 may include one or more openings therein that provide access to the interior of the base portion 22 when the top door 40 is closed. For example, one opening and an associated bezel 60 may provide access to a media printer (not shown) which is located in the interior space of the base portion 22. A second opening and associated bezel 64 may provide access to a media reader which is located in the interior of the base portion 22.

Preferably, a video display 68 is also associated with the top door 40, such as the display mount 44. As illustrated, the display mount 44 may house at least a portion of the video display 68, such as having an interior space in which at least a bottom portion of the video display 68 is located. As illustrated, in such a configuration, a viewing face of the video display 68 may face upwardly from the display mount 44 and be generally flush with an upper surface of the display mount 44.

The video display 68 is preferably a panel style display, such as an LED, OLED, plasma or similar display. As illustrated, the video display 68 may have a bottom which corresponds to the front 46 of the display mount 44, a top which corresponds to the rear 52 of the display mount 44, and first and second sides which correspond to the first and second sides 48,50 of the display mount 44.

In one embodiment, as best illustrated in FIGS. 4 and 5, the video display 68 has a curved screen, such as where at least a front or viewing face thereof is concave curved. In such a configuration, the viewing face of the video display 68 curves towards the player (such as compared to a flat panel display) moving from the bottom to the top thereof (from the front 46 to the rear 52 of the display mount 44). Of course, the video display 68 might have other configurations, such as being generally flat.

In one embodiment, as best illustrated in FIG. 5, the display 68 may extend upwardly at an angle Θ of about 20 degrees, such as to facilitate viewing by a user at the front of the bar top gaming unit 20.

Most importantly, as illustrated in FIG. 1, the video display 68 is located in “portrait” orientation relative to the bar top gaming unit 20 and the player thereof. In particular, as illustrated, the video display has a first dimension D1 between its bottom and top which is greater than a second dimension D2 between its sides. As is known, the ratio of the these dimensions might be D1/D2=4:3 or, more commonly and illustrated, D1/D2=16:9. Further, the video display 68 is oriented so that the top and bottom thereof (and thus the dimension D2) extends generally parallel to the front of the bar top gaming unit 20 and in the “SS” direction of the bar top gaming unit 20, and the sides thereof (and thus the dimension D1) extends generally perpendicular to the front of the bar top gaming unit and in the “FR” direction of the bar top gaming unit 20. In this configuration, a player who is located at the front of the bar top gaming unit 20 faces into the “FR” direction and thus the direction of dimension D1 of the video display.

Of course, the principles of the disclosure such as the portrait oriented video display, may be applied to bar top gaming units having other configurations, such as having top doors of other configurations and different arrangements of secondary components such as input buttons, printer bezels/slots, tracking card bezels/slots etc.

It will be understood that the above-described arrangements of apparatus and the method there from are merely illustrative of applications of the principles of this disclosure and many other embodiments and modifications may be made without departing from the spirit and scope of the disclosure as defined in the claims.

What is claimed is:

1. A bar top gaming unit comprising:
a housing comprising:
a base portion having a bottom and at least one wall extending upwardly to a top, said base portion generally defining an interior area for housing one or more components of said bar top gaming unit;
a top door located at said top of said base portion; and
a display mount associated with said top door;
wherein said housing has a front and an opposing rear and first and second sides and a first direction that is generally parallel to said first and second sides and perpendicular to said front and rear, and a second direction that is generally parallel to said front and rear and perpendicular to said first and second sides;
and
a video display having a top and a bottom and a first side and a second side, a first dimension D1 between said top and bottom which is greater than a second distance D2 between said first side and said second side, said video display connected to sad display mount and oriented so that said dimension D1 extends parallel to said first direction and generally perpendicular to said second direction.

2. The bar top gaming unit in accordance with claim 1 wherein said top of said video display is located at a first elevation which is higher than a second elevation of said bottom of said video display.

3. The bar top gaming unit in accordance with claim 1, wherein said top door has a front and a rear and said display mount has a front and a rear, said rear of said display mount being located rearwardly of said rear of said top door in reference to said front of said top door.

4. The bar top gaming unit in accordance with claim 1, wherein said video display has a viewing face which is concave in shape between its top and bottom.

5. The bar top gaming unit in accordance with claim 1, further comprising a console located at said top of said top door.

6. The bar top gaming unit in accordance with claim 5, wherein said top door has a front and said console is located between said front of said top door and said bottom of said video display.

7. The bar top gaming unit in accordance with claim 6, wherein said console is associated with said display mount.

8. The bar top gaming unit in accordance with claim 1, wherein said display mount defines an interior space and has an open top, said video display is at least partially located in said interior space of said display mount.

9. The bar top gaming unit in accordance with claim 1, wherein said display mount has first and second opposing sides and a front and a rear, wherein said sides extend upwardly from said top door.

10. The bar top gaming unit in accordance with claim 1, wherein said video display angles upwardly relative to said top door from said bottom to said top of said video display at an angle of about 20 degrees.

11. A bar top gaming unit comprising:
a housing having a top defining a front, a rear, a first side and a second side of said bar top gaming unit;
a display mount extending upwardly from said top; and
a video display connected to said display mount, said video display having a top and a bottom and a first side and a second side, a first dimension D1 between said top and bottom which is greater than a second distance D2 between said first side and said second side, said video display oriented so that said dimension D1 extends generally perpendicular to said front of said bar top gaming unit.

12. The bar top gaming unit in accordance with claim 11, wherein said top of said video display is located above said top of said housing.

13. The bar top gaming unit in accordance with claim 11, wherein said top of said video display is located rearwardly of said rear of said bar top gaming unit.

14. The bar top gaming unit in accordance with claim 11, wherein said top of said housing is at least partially defined by a top door.

15. The bar top gaming unit in accordance with claim 14, wherein said display mount is connected to said top door.

16. The bar top gaming unit in accordance with claim 11, wherein said video display has a concave viewing face.

17. The bar top gaming unit in accordance with claim 11, wherein said video display extends upwardly from said bottom to said top at an angle of about 20 degrees.

18. The bar top gaming unit in accordance with claim 11, further comprising a console associated with said display mount.

19. The bar top gaming unit in accordance with claim 11, further comprising at least one player input device associated with said console.
